(19) United States
(12) Patent Application Publication
(10) Pub. No.: US 2019/0299800 A1
(43) Pub. Date: Oct. 3, 2019

(54) WIRELESS POWER TRANSMISSION DEVICE AND WIRELESS POWER TRANSMISSION SYSTEM

(71) Applicant: TDK CORPORATION, Tokyo (JP)

(72) Inventors: Ryo MIYAZAWA, Tokyo (JP); Masahide OHNISHI, Tokyo (JP)

(73) Assignee: TDK CORPORATION, Tokyo (JP)

(21) Appl. No.: 16/367,004

(22) Filed: Mar. 27, 2019

(30) Foreign Application Priority Data
Mar. 30, 2018 (JP) 2018-069836

(51) Int. Cl. B60L 53/12; H02J 50/12; H02J 7/02

(52) U.S. Cl. CPC B60L 53/12; B60L 2210/30; H02J 7/025; H02J 50/12

(57) ABSTRACT

A wireless power transmission device capable of preventing a lifespan of a capacitor that smooths a voltage rectified by a rectification circuit from being shortened, including a power transmission coil magnetically coupled to the power receiving coil, a rectification circuit that rectifies a supplied AC voltage, a first capacitor that smooths a voltage supplied from the rectification circuit into DC voltage, a power transmission circuit that converts the DC voltage smoothed by the first capacitor into AC voltage at a driving frequency, and a second capacitor that bypasses between two transmission paths connecting the circuits, the second capacitor is provided on the power transmission circuit side relative to the first capacitor between the rectification circuit and the power transmission circuit, and the device includes an inductor or rectification element between the first and second capacitor in the high potential side transmission path among the two transmission paths.

### BACKGROUND OF THE INVENTION

### Field of the Invention

The present invention relates to a wireless power transmission device and a wireless power transmission system.

Priority is claimed on Japanese Patent Application No. 2018-069836, filed Mar. 30, 2018, the content of which is incorporated herein by reference.

### Description of Related Art

Research or development of technologies regarding wireless power transmission, which is wireless-based transmission of power, is being conducted.

In this regard, a wireless power transmission device that transmits a power to a power receiving coil included in a wireless power reception device through wireless power transmission, the wireless power transmission device including a power transmission coil magnetically coupled to a power receiving coil, a rectification circuit that rectifies an input alternating current (AC) voltage, a smoothing capacitor that smooths a voltage rectified by the rectification circuit into a direct current (DC) voltage, and a power transmission circuit that converts the DC voltage smoothed by the smoothing capacitor into an AC voltage at a driving frequency and supplies the converted AC voltage to the power transmission coil is known (see Patent Document 1).

### PATENT DOCUMENTS

[Patent Document 1] Japanese Unexamined Patent Application, First Publication No. 2012-152041

### SUMMARY OF THE INVENTION

A wireless power transmission system including such a wireless power transmission device and such a wireless power reception device may be applied to a battery charging system or the like mounted on a movable body such as an electric car. In such a case, a relative position between the power transmission coil and the power receiving coil during the wireless power transmission is often different depending on a difference in height (for example, a difference in height of the electric car) according to a type of the movable body (for example, a type of electric car), a difference in width of an allowable range of a stop position of the movable body, and the like. As a result, in this case, in the wireless power transmission device, it may be difficult for a phase of an alternating current (AC) supplied from the power transmission circuit to the power transmission coil to match a phase of an AC voltage supplied from the power transmission circuit to the power transmission coil. When a phase of the AC current supplied from the power transmission circuit to the power transmission coil does not match a phase of the AC voltage supplied from the power transmission circuit to the power transmission coil, a reactive current flows in a stage before the power transmission circuit. As a result, a ripple of a direct current (DC) current supplied to the power transmission circuit increases. When the ripple of the DC current supplied to the power transmission circuit increases, a lifespan of the smoothing capacitor may be shortened.

The present invention has been made in consideration of such circumstances, and an object of the present invention is to provide a wireless power transmission device, and a wireless power transmission system capable of preventing a lifespan of a capacitor that smooths a voltage rectified by a rectification circuit from being shortened.

An aspect of the present invention is a wireless power transmission device that transmits an AC power to a power receiving coil included in a wireless power reception device, the wireless power transmission device including a power transmission coil magnetically coupled to the power receiving coil; a rectification circuit that rectifies a supplied AC voltage; a first capacitor that is provided between two output terminals of the rectification circuit and smooths a voltage supplied from the rectification circuit into a DC voltage; a power transmission circuit that converts the DC voltage smoothed by the first capacitor into an AC voltage at a driving frequency; and a second capacitor provided between two input terminals included in the power transmission circuit and bypassing between two transmission paths connecting the rectification circuit and the power transmission circuit, wherein the second capacitor is provided on the power transmission circuit side relative to the first capacitor between the rectification circuit and the power transmission circuit, and the wireless power transmission device includes an inductor or a rectification element provided between the first capacitor and the second capacitor in the high potential side transmission path among the two transmission paths.

According to the present invention, it is possible to prevent a lifespan of a capacitor that smooths a voltage rectified by a rectification circuit from being shortened.

### BRIEF DESCRIPTION OF THE DRAWINGS

FIG. 1 is a diagram illustrating an example of a configuration of a wireless power transmission system 1 according to an embodiment.

FIG. 2 is a diagram illustrating an example of a configuration of a wireless power transmission device 10.

FIG. 3 is a graph showing an example of respective changes in a first current ratio and a second current ratio with respect to a change in a cutoff frequency of an effective low pass filter when an inductance of an inductor L is changed.

FIG. 4 is a graph showing another example of respective changes in a first current ratio and a second current ratio with respect to a change in a cutoff frequency of an effective low pass filter when an inductance of an inductor L is changed.

FIG. 5 is a graph showing still another example of respective changes in a first current ratio and a second current ratio with respect to a change in a cutoff frequency of an effective low pass filter when an inductance of an inductor L is changed.

### DETAILED DESCRIPTION OF THE INVENTION

### Embodiments

Hereinafter, embodiments of the present invention will be described with reference to the drawings. Here, in the embodiment, wireless-based transmission of a power is referred to as wireless power transmission for convenience of description. Further, in the embodiment, a conductor that transmits an electric signal according to a direct current (DC) power or an electric signal according to an alternating current (AC) power is referred to as a transmission path. The transmission path is, for example, a conductor printed on a substrate. Note that the transmission path may be, for example, instead of the conductor, a conductive line that is a conductor formed in a line shape.

<Overview of Wireless Power Transmission System>

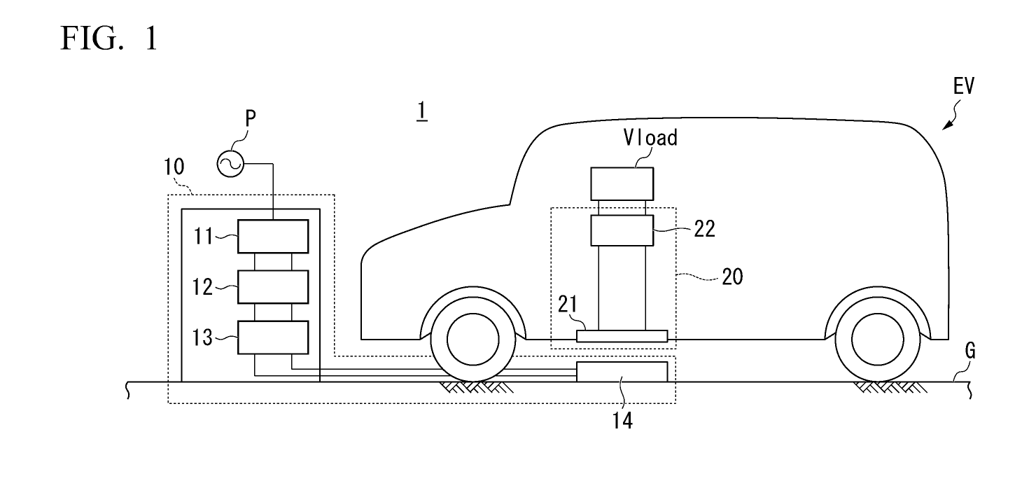

First, an overview of a wireless power transmission system 1 according to an embodiment will be described. FIG. 1 is a diagram illustrating an example of a configuration of a wireless power transmission system 1 according to the embodiment.

The wireless power transmission system 1 includes a wireless power transmission device 10 and a wireless power reception device 20.

In the wireless power transmission system 1, power is transmitted from the wireless power transmission device 10 to the wireless power reception device 20 through wireless power transmission. More specifically, in the wireless power transmission system 1, power is transmitted from the power transmission coil L1 (not illustrated in FIG. 1) included in the wireless power transmission device 10 to a power receiving coil L2 (not illustrated in FIG. 1) included in the wireless power reception device 20. The wireless power transmission system 1 performs, for example, wireless power transmission using a magnetic field resonance scheme. Note that the wireless power transmission system 1 may be configured to perform wireless power transmission using another scheme instead of the magnetic field resonance scheme.

Hereinafter, a case in which the wireless power transmission system 1 is applied to a system that performs charging through wireless power transmission to a battery (a secondary battery) mounted in an electric car EV as illustrated in FIG. 1 will be described by way of example. The electric car EV is an electric car (a movable body) that travels by driving a motor with power charged in the battery. In the example illustrated in FIG. 1, the wireless power transmission system 1 includes the wireless power transmission device 10 installed on the ground G on the charging facility side and the wireless power reception device 20 mounted on the electric car EV. Note that that the wireless power transmission system 1 may be, instead of the configuration in which the wireless power transmission system 1 is applied to the system, a configuration in which the wireless power transmission system 1 is applied to other devices, other systems, and the like.

Here, in the wireless power transmission according to the magnetic field resonance scheme, the wireless power transmission system 1 causes resonance frequencies of a power transmission side resonance circuit (not illustrated) included in the wireless power transmission device 10 (included in a power transmission coil unit 14 to be described below in the example illustrated in FIG. 1) and a power reception side resonance circuit (not illustrated) included in the wireless power reception device 20 (included in the power receiving coil unit 21 in the example illustrated in FIG. 1) to be close to each other (or causes the resonance frequencies to match each other), applies a high frequency current and voltage at a frequency near the resonance frequency to the power transmission coil unit 14, and wirelessly transmits (supplies) the power to the electromagnetically resonated power receiving coil unit 21.

Therefore, the wireless power transmission system 1 of the embodiment can perform charging on a battery mounted in the electric car EV using wireless power transmission while wirelessly transmitting a power supplied from a charging facility to the electric car EV without connection to a charging cable.

The wireless power transmission system 1 will be described herein through a comparison of the wireless power transmission system 1 with a wireless power transmission system 1X different from the wireless power transmission system 1. The wireless power transmission system 1X is, for example, a wireless power transmission system of the related art. The wireless power transmission system 1X includes a wireless power transmission device 10X and a wireless power reception device 20X. The wireless power transmission device 10X is, for example, a wireless power transmission device of the related art. The wireless power reception device 20X is, for example, a wireless power reception device of the related art.

In the wireless power transmission system 1X, the wireless power transmission device 10X includes, for example, a power transmission coil L1X magnetically coupled to a power receiving coil L2X included in the wireless power reception device 20X, a rectification circuit that rectifies an input AC voltage, a smoothing capacitor which smooths a voltage rectified by the AC voltage to a DC voltage, and a power transmission circuit that converts the DC voltage smoothed by the smoothing capacitor to an AC voltage at driving frequency and supplies the converted AC voltage to the power transmission coil L1X.

Such a wireless power transmission system 1X may be applied to, for example, a battery charging system mounted on a movable body such as the electric car EV described above, similar to the wireless power transmission system 1 in this example. In such a case, a relative position of the power transmission coil L1X and the power receiving coil L2X during wireless power transmission is different depending on a difference in height (for example, a difference in height of the electric car) according to a type of the movable body (for example, a type of electric car), a difference in width of an allowable range of a stop position of the movable body, and the like. As a result, in this case, in the wireless power transmission device 10X, it may be difficult for a phase of an AC current supplied from the power transmission circuit included in the wireless power transmission device 10X to the power transmission coil L1X to match a phase of an AC voltage supplied from the power transmission circuit to the power transmission coil L1X. When a phase of the AC current supplied from the power transmission circuit to the power transmission coil L1X does not match a phase of the AC voltage supplied from the power transmission circuit to the power transmission coil L1X, a reactive current flows in a stage before the power transmission circuit. As a result, the ripple of the DC current supplied to the power transmission circuit increases. When the ripple of the DC current supplied to the power transmission circuit increases, a lifespan of the smoothing capacitor included in the wireless power transmission device 10X may be shortened.

Unlike the wireless power transmission system 1X, the wireless power transmission device 10 in the wireless power transmission system 1 includes a power transmission coil L1 magnetically coupled to the power receiving coil L2, a rectification circuit that rectifies a supplied AC voltage, a first capacitor that is provided between two output terminals of the rectification circuit and smooths a voltage supplied from the rectification circuit into a DC voltage, a power transmission circuit that converts the DC voltage smoothed by the first capacitor into an AC voltage at a driving frequency, and a second capacitor provided between two input terminals included in the power transmission circuit and bypassing between the two transmission paths connecting the rectification circuit and the power transmission circuit. Further, in the wireless power transmission device 10, the second capacitor is provided on the power transmission circuit side relative to the first capacitor between the rectification circuit and the power transmission circuit. Further, the wireless power transmission device 10 includes an inductor or a rectification element provided between the first capacitor and the second capacitor in the high potential side transmission path among the two transmission paths. Accordingly, the wireless power transmission system 1 and the wireless power transmission device 10 can prevent a flow of a reactive current flowing in a preceding stage of the power transmission circuit from flowing to the first capacitor. As a result, the wireless power transmission system 1 and the wireless power transmission device 10 can prevent a lifespan of the first capacitor that smooths the voltage rectified by the rectification circuit from being shortened. Hereinafter, configurations of the wireless power transmission system 1 and the wireless power transmission device 10 will be described in detail.

<Configuration of Wireless Power Transmission System>

Hereinafter, a configuration of the wireless power transmission system 1 will be described with reference to FIG. 1.

The wireless power transmission device 10 includes a conversion circuit 11, an addition circuit 12, a power transmission circuit 13, and a power transmission coil unit 14. On the other hand, the wireless power reception device 20 includes a power receiving coil unit 21 and a rectifying and smoothing circuit 22. The wireless power reception device 20 can be connected to a load Vload. In the example illustrated in FIG. 1, the wireless power reception device 20 is connected to the load Vload. Note that the wireless power reception device 20 may have a configuration in which the load Vload is included.

The conversion circuit 11 is, for example, an AC/DC converter which is connected to an external commercial power supply P and converts an AC voltage input from the commercial power supply P into a desired DC voltage. The conversion circuit 11 is connected to the power transmission circuit 13 via the addition circuit 12. The conversion circuit 11 supplies the DC voltage obtained by converting the AC voltage to the power transmission circuit 13 via the addition circuit 12.

Note that the conversion circuit 11 may be of any type as long as the conversion circuit supplies a DC voltage to the power transmission circuit 13 via the addition circuit 12. For example, the conversion circuit 11 may be a conversion circuit in which a rectifying and smoothing circuit that rectifies an AC voltage into a DC voltage and a power factor correction (PFC) circuit that performs power factor correction are combined, may be a conversion circuit in which the rectifying and smoothing circuit and a switching circuit such as a switching converter are combined, or may be another conversion circuit that outputs a DC voltage to the power transmission circuit 13 via the addition circuit 12 among conversion circuits including the rectifying and smoothing circuit.

The addition circuit 12 is a circuit that functions as a low pass filter when a reactive current flows from the power transmission circuit 13 to be described below together with the smoothing capacitor (a first capacitor C1 to be described below) of the rectifying and smoothing circuit constituting the conversion circuit 11.

The power transmission circuit 13 converts the DC voltage supplied from the conversion circuit 11 via the addition circuit 12 into an AC voltage. For example, the power transmission circuit 13 is a switching circuit in which a plurality of switching elements are bridge-connected. The power transmission circuit 13 is connected to the power transmission coil unit 14. The power transmission circuit 13 supplies an AC voltage, of which a driving frequency is controlled, to the power transmission coil unit 14 on the basis of the resonance frequency of the power transmission side resonance circuit included in the power transmission coil unit 14 to be described below.

The power transmission coil unit 14 includes, for example, an LC resonance circuit including a power transmission coil L1 (not illustrated in FIG. 1) and a capacitor (not illustrated) as the power transmission side resonance circuit. In this case, in the power transmission coil unit 14, the resonance frequency of the power transmission side resonance circuit can be adjusted by adjusting a capacitance of the capacitor. The wireless power transmission device 10 causes the resonance frequency of the power transmission side resonance circuit to be close to (or match) the resonance frequency of the power reception side resonance circuit included in the power receiving coil unit 21 to thereby perform wireless power transmission using a magnetic field resonance scheme. Note that the power transmission coil unit 14 may include another resonance circuit including the power transmission coil L1 as a power transmission side resonance circuit instead of the LC resonance circuit. The power transmission coil unit 14 may include another circuit, another circuit element, and the like, in addition to the power transmission side resonance circuit. Further, the power transmission coil unit 14 may include a magnetic member that enhances magnetic coupling between the power transmission coil L1 and the power receiving coil L2, and an electromagnetic shield that suppresses leakage of a magnetic field generated by the power transmission coil L1 to the outside.

The power transmission coil L1, for example, is a coil for wireless power transmission in which a litz wire made of copper, aluminum, or the like is wound in a spiral shape. The power transmission coil L1 of the embodiment is installed on the ground G or embedded in the ground G to face the lower side of a floor of the electric car EV. Hereinafter, a case in which the power transmission coil L1 (that is, the power transmission coil unit 14) is installed on the ground G together with the power transmission circuit 13 will be described by way of example.

Note that the wireless power transmission device 10 further includes a control circuit (not illustrated). The control circuit controls the wireless power transmission device 10. Further, the wireless power transmission device 10 includes a wireless communication circuit (not illustrated) that performs transmission and reception of various pieces of information to and from the wireless power reception device 20 through wireless communication based on a standard such as Wi-Fi (registered trademark).

The power receiving coil unit 21 includes, for example, an LC resonance circuit including a power receiving coil L2 (not illustrated in FIG. 1) and a capacitor (not illustrated) as the power reception side resonance circuit. In this case, in the power receiving coil unit 21, the resonance frequency of the power reception side resonance circuit can be adjusted by adjusting a capacitance of the capacitor. The wireless power reception device 20 causes the resonance frequency of the power reception side resonance circuit to be close to (or match) the resonance frequency of the power transmission side resonance circuit to thereby perform wireless power transmission using a magnetic field resonance scheme. Note that the power receiving coil unit 21 may include another resonance circuit including the power receiving coil L2 as a power reception side resonance circuit instead of the LC resonance circuit. Further, the power receiving coil unit 21 may include another circuit, another circuit element, and the like in addition to the power reception side resonance circuit. Further, the power receiving coil unit 21 may include a magnetic member that enhances magnetic coupling between the power transmission coil L1 and the power receiving coil L2, and an electromagnetic shield that suppresses leakage of a magnetic field generated by the power transmission coil L1 to the outside.

The rectifying and smoothing circuit 22 is connected to the power receiving coil unit 21 and rectifies the AC voltage supplied from the power receiving coil L2 and converts the resultant voltage into a DC voltage. The rectifying and smoothing circuit 22 can be connected to the load Vload. In the example illustrated in FIG. 1, the rectifying and smoothing circuit 22 is connected to the load Vload. When the rectifying and smoothing circuit 22 is connected to the load Vload, the rectifying and smoothing circuit 22 supplies the converted DC voltage to the load Vload. Note that in the wireless power reception device 20, the rectifying and smoothing circuit 22 may be connected to the load Vload via a charging circuit when the rectifying and smoothing circuit 22 is connected to the load Vload.

Here, when the load Vload is connected to the rectifying and smoothing circuit 22, a DC voltage is supplied from the rectifying and smoothing circuit 22. For example, the load Vload is a battery mounted on the electric car EV described above, a motor mounted on the electric car EV, or the like. The load Vload is a resistive load in which an equivalent resistance value varies with time according to a demand state (storage state or consumption state) of electric power. Note that in the wireless power reception device 20, the load Vload may be another load to which a DC voltage is supplied from the rectifying and smoothing circuit 22 instead of the battery, the motor, and the like.

Note that the wireless power reception device 20 further includes a control circuit (not illustrated). The control circuit controls the wireless power reception device 20. Further, the wireless power reception device 20 includes a wireless communication circuit (not illustrated) that performs transmission and reception of various pieces of information to and from the wireless power transmission device 10 through wireless communication based on a standard such as Wi-Fi (registered trademark).

<Configuration of Wireless Power Reception Device>

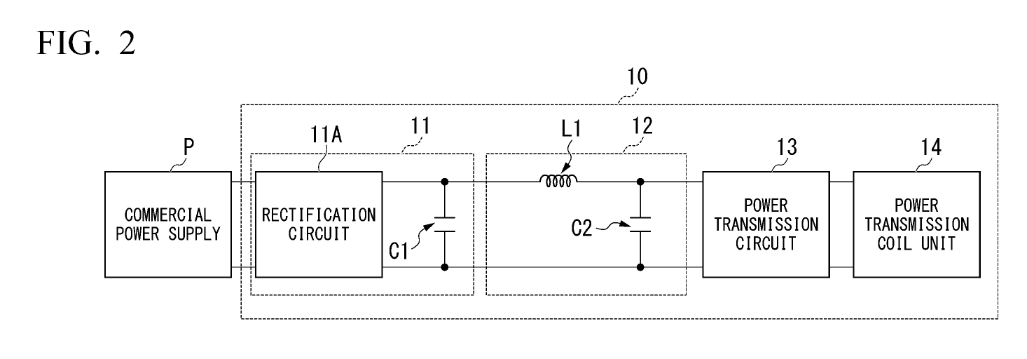

Hereinafter, a configuration of the wireless power transmission device 10 will be described with reference to FIG. 2. FIG. 2 is a diagram illustrating an example of a configuration of the wireless power transmission device 10.

As described above, the wireless power transmission device 10 includes a conversion circuit 11, an addition circuit 12, a power transmission circuit 13, and a power transmission coil unit 14. The conversion circuit 11 includes a rectification circuit 11A and a first capacitor C1. Further, the addition circuit 12 includes a second capacitor C2 and an inductor L. Note that the addition circuit 12 may have a configuration in which a rectification element is provided instead of the inductor L.

The rectification circuit 11A rectifies a supplied AC voltage and converts the resultant voltage into a pulsating voltage. In the example illustrated in FIG. 2, one of two input terminals included in the rectification circuit 11A is connected to one of the two output terminals included in the commercial power supply P described above by a transmission path. Further, the other of the two input terminals is connected to the other of the two output terminals by a transmission path. Therefore, in this example, the rectification circuit 11A rectifies the AC voltage supplied from the commercial power supply P and converts the resultant voltage into a pulsating voltage. For example, the rectification circuit 11A may be a half-wave rectification circuit including one switching element, may be a half-wave rectification circuit including one diode, may be a full-wave rectification circuit including four bridge-connected switching elements or four diodes, or may be another rectification circuit that rectifies a supplied AC voltage and converts the resultant voltage into a pulsating voltage. The pulsating voltage rectified by the rectification circuit 11A is smoothed into a DC voltage by the first capacitor C1. That is, the conversion circuit 11 described above rectifies the supplied AC voltage and converts the resultant voltage into a DC voltage.

Further, one of the two output terminals included in the rectification circuit 11A is an output terminal on the high potential side and is connected to the high potential side input terminal of the two input terminals included in the power transmission circuit 13 by a transmission path. Further, the other of the two output terminals is an output terminal on the low potential side and is connected to an input terminal on the low potential side of the two input terminals by a transmission path. That is, the conversion circuit 11 supplies the DC voltage smoothed by the first capacitor C1 to the power transmission circuit 13.

The first capacitor C1 is an electrolytic capacitor. The first capacitor C1 is provided between the two output terminals included in the rectification circuit 11A. As described above, the first capacitor C1 is a smoothing capacitor that smooths the ripple voltage rectified by the rectification circuit 11A to a DC voltage.

The second capacitor C2 is a capacitor different in type from the first capacitor C1. That is, the second capacitor C2 is a capacitor different from the electrolytic capacitor. Specifically, for example, the second capacitor C2 is a film capacitor. The second capacitor C2 is a bypass capacitor that is provided between the two input terminals of the power transmission circuit 13 and bypasses between the two transmission paths connecting the rectification circuit 11A and the power transmission circuit 13. Here, the second capacitor C2 is provided on the power transmission circuit 13 side of the first capacitor C1 between the rectification circuit 11A and the power transmission circuit 13.

The inductor L is, for example, a coil. Note that the inductor L may be another inductor instead of the coil. The inductor L is provided between the first capacitor C1 and the second capacitor C2 in the high potential side transmission path among the two transmission paths connecting the rectification circuit 11A and the power transmission circuit 13.

In the wireless power transmission device 10, the second capacitor C2 and the inductor L are provided as described above. Therefore, even when the phase of the AC current supplied from the power transmission circuit 13 to the power transmission coil L1 does not match the phase of the AC voltage supplied from the power transmission circuit 13 to the power transmission coil L1, the wireless power transmission device 10 can prevent the reactive current from flowing from the power transmission circuit 13 to the rectification circuit 11A. Further, in this case, the wireless power transmission device 10 can suppress the reactive current from flowing to the first capacitor C1 due to the second capacitor C2, which is a bypass capacitor. As a result, the wireless power transmission system 1 and the wireless power transmission device 10 can prevent a lifespan of the first capacitor C1 that smooths the pulsating voltage rectified by the rectification circuit 11A from being shortened.

Here, the addition circuit 12 functions as a low pass filter for the reactive current flowing from the power transmission circuit 13 when the phase of the AC current supplied from the power transmission circuit 13 to the power transmission coil L1 does not match the phase of the AC voltage supplied from the power transmission circuit 13 to the power transmission coil L1, in which the low pass filter has a cutoff frequency according to the capacitance of the first capacitor C1 and the inductance of the inductor L with respect to the DC voltage supplied from the conversion circuit 11. The inductance is determined so that the cutoff frequency is lower than the driving frequency of the power transmission circuit 13. Accordingly, in this case, in the wireless power transmission device 10, it is possible to prevent the reactive current from flowing from the power transmission circuit 13 to the conversion circuit 11, and as a result, it is possible to more reliably prevent the reactive current from flowing from the power transmission circuit 13 to the first capacitor C1. Note that the reactive current flowing from the first capacitor C1 to the rectification circuit 11A is a current having a negligible magnitude even when the reactive current is present and there is substantially no reactive current. Therefore, the reactive current flowing from the power transmission circuit 13 to the rectification circuit 11A via the first capacitor C1 is substantially not included in the reactive current flowing from the power transmission circuit 13 to the rectification circuit 11A.

Further, in the wireless power transmission device 10, the first capacitor C1, the second capacitor C2, and the inductor L function as a low pass filter for the reactive current flowing from the power transmission circuit 13 when the phase of the AC current supplied from the power transmission circuit 13 to the power transmission coil L1 does not match the phase of the AC voltage supplied from the power transmission circuit 13 to the power transmission coil L1, in which the low pass filter has a cutoff frequency according to the capacitance of the first capacitor C1, the capacitance of the second capacitor C2, and the inductance of the inductor L with respect to the pulsating voltage supplied from the rectification circuit 11A. The cutoff frequency changes as the capacitance of the first capacitor C1, the capacitance of the second capacitor C2, and the inductance change. Therefore, in the wireless power transmission device 10, in this case, the capacitance of the first capacitor C1, the capacitance of the second capacitor C2, and the inductance of the inductor L are determined so that the reactive current flowing from the power transmission circuit 13 to the first capacitor C1 is smaller than the reactive current flowing from the power transmission circuit 13 toward the rectification circuit 11A and smaller than the reactive current flowing from the power transmission circuit 13 to the second capacitor C2. Accordingly, in this case, the wireless power transmission device 10 can more reliably suppress the reactive current from flowing from the power transmission circuit 13 to the first capacitor C1.

<Specific Example 1 of Cutoff Frequency of Low Pass Filter in Wireless Power Transmission Device>

Hereinafter, specific example 1 of the cutoff frequency of the low pass filter in the wireless power transmission device 10 will be described. As described above, in the wireless power transmission device 10, the first capacitor C1, the second capacitor C2, and the inductor L function as a low pass filter for the reactive current flowing from the power transmission circuit 13 when the phase of the AC current supplied from the power transmission circuit 13 to the power transmission coil L1 does not match the phase of the AC voltage supplied from the power transmission circuit 13 to the power transmission coil L1, in which the low pass filter has a cutoff frequency according to the capacitance of the first capacitor C1, the capacitance of the second capacitor C2, and the inductance of the inductor L with respect to the pulsating voltage supplied from the rectification circuit 11A. Hereinafter, the low pass filter will be referred to as an effective low pass filter for convenience of description.

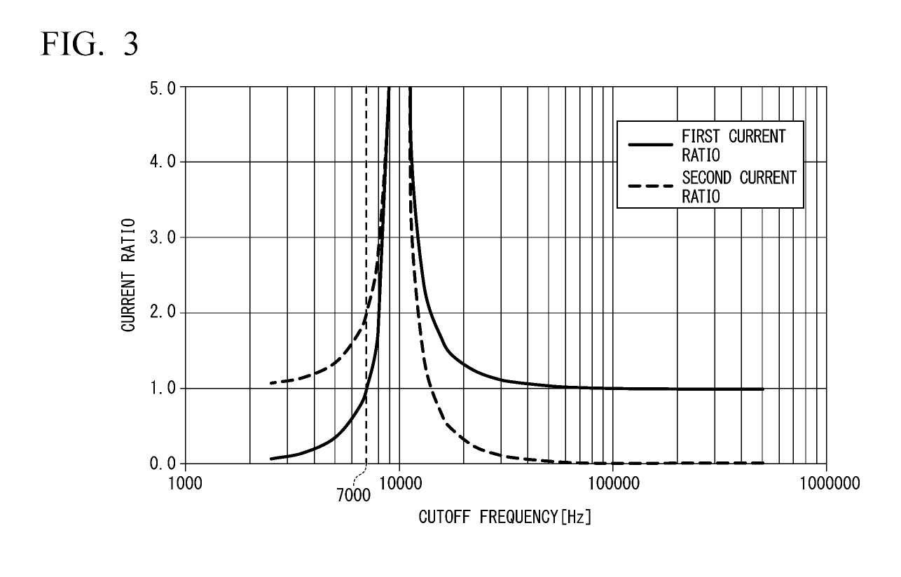

For example, in a certain simulation, when the capacitance of the first capacitor C1 is 1 [mF], the capacitance of the second capacitor C2 is 10 [μF], and the driving frequency of the power transmission circuit 13 is 100 [kHz], it is preferable for the cutoff frequency of the effective low pass filter to be about 7 kHz or less. However, in this case, it can be preferable for the cutoff frequency to be a frequency equal to or lower than a frequency higher than 7 [kHz] due to an influence of other impedances such as an impedance of the rectification circuit 11A and an impedance of the power transmission circuit 13. Here, FIG. 3 is a graph showing an example of respective changes in the first current ratio and the second current ratio with respect to the change in the cutoff frequency of the effective low pass filter when the inductance of the inductor L is changed. Specifically, FIG. 3 is a graph showing an example of respective changes in the first current ratio and the second current ratio with respect to the change in the cutoff frequency of the effective low pass filter when the inductance of the inductor L is changed in a case in which the capacitance of the first capacitor C1 is 1 [mF], the capacitance of the second capacitor C2 is 10 [μF], and the driving frequency of the power transmission circuit 13 is 100 [kHz].

The first current ratio is a value obtained by dividing a first reactive current by a zero-th reactive current, that is, a ratio of the first reactive current to the zero-th reactive current. The zero-th reactive current is a reactive current flowing from the power transmission circuit 13 to the rectification circuit 11A (there is substantially no reactive current flowing from the first capacitor C1 to the rectification circuit 11A as described above). The first reactive current is a reactive current flowing from the power transmission circuit 13 to the first capacitor C1. A second current ratio is a value obtained by dividing a second reactive current by the zero-th reactive current, that is, a ratio of the second reactive current to the zero-th reactive current. The second reactive current is a reactive current flowing from the power transmission circuit 13 to the second capacitor C2.

As illustrated in FIG. 3, when the cutoff frequency of the effective low pass filter is 7 kHz or less, the second current ratio is equal to or higher than 1, whereas the first current ratio is lower than 1. That is, this indicates that, in a simulation performed by the inventors of the present invention when the capacitance of the first capacitor C1 is 1 [mF], the capacitance of the second capacitor C2 is 10 [μF], and the driving frequency of the power transmission circuit 13 is 100 [kHz], it is preferable for the cutoff frequency of the effective low pass filter to be about 7 [kHz] or less. Here, in this simulation, in this case, the cutoff frequency being about 7 [kHz] or less corresponds to the inductance of the inductor L being about 50 [μH] or less.

<Specific Example 2 of Cutoff Frequency of Low Pass Filter in Wireless Power Transmission Device>

Hereinafter, specific example 2 of the cutoff frequency of the low pass filter in the wireless power transmission device 10 will be described.

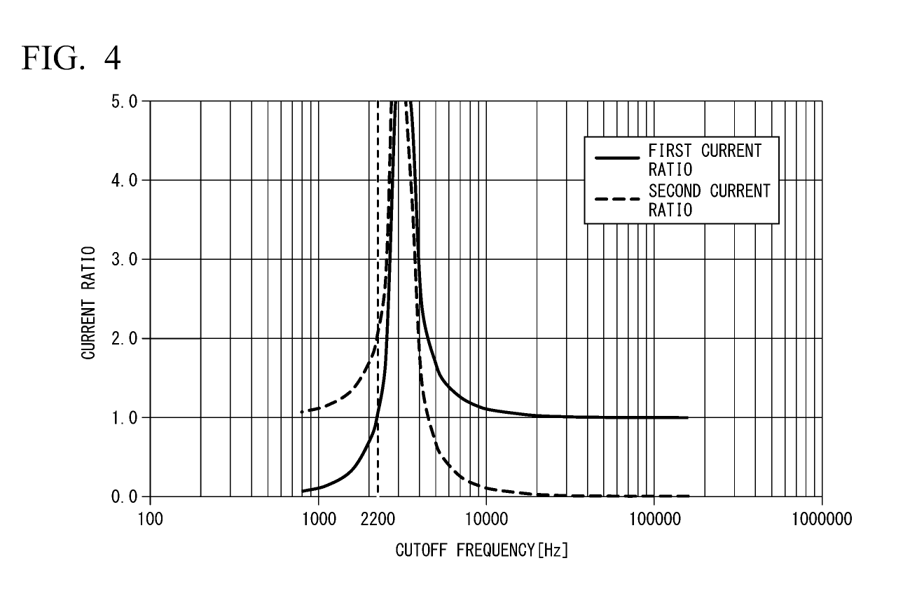

For example, in a certain simulation, the capacitance of the first capacitor C1 is 10 [mF], the capacitance of the second capacitor C2 is 10 [μF], and the driving frequency of the power transmission circuit 13 is 100 [kHz], it is preferable for the cutoff frequency of the effective low pass filter to be about 2.2 [kHz] or less. However, in this case, it can be preferable for the cutoff frequency to be a frequency equal to or lower than a frequency higher than 2.2 [kHz] due to an influence of other impedances such as the impedance of the rectification circuit 11A and the impedance of the power transmission circuit 13. Here, FIG. 4 is a graph showing another example of respective changes in the first current ratio and the second current ratio with respect to the change in the cutoff frequency of the effective low pass filter when the inductance of the inductor L is changed. Specifically, FIG. 4 is a graph showing an example of respective changes in the first current ratio and the second current ratio with respect to the change in the cutoff frequency of the effective low pass filter when the inductance of the inductor L is changed in a case in which the capacitance of the first capacitor C1 is 10 [mF], the capacitance of the second capacitor C2 is 10 [μF], and the driving frequency of the power transmission circuit 13 is 100 [kHz].

As illustrated in FIG. 4, when the cutoff frequency of the effective low pass filter is 2.2 [kHz] or less, the second current ratio is equal to or higher than 1, whereas the first current ratio is lower than 1. That is, this indicates that, in a simulation performed by the inventors of the present invention, when the capacitance of the first capacitor C1 is 10 [mF], the capacitance of the second capacitor C2 is 10 [g], and the driving frequency of the power transmission circuit 13 is 100 [kHz], it is preferable for the cutoff frequency of the effective low pass filter to be about 2.2 [kHz] or less. Here, in this simulation, in this case, the cutoff frequency being about 2.2 [kHz] or less corresponds to the inductance of the inductor L being about 50 [μH] or less.

<Specific Example 3 of Cutoff Frequency of Low Pass Filter in Wireless Power Transmission Device>

Hereinafter, specific example 3 of the cutoff frequency of the low pass filter in the wireless power transmission device 10 will be described.

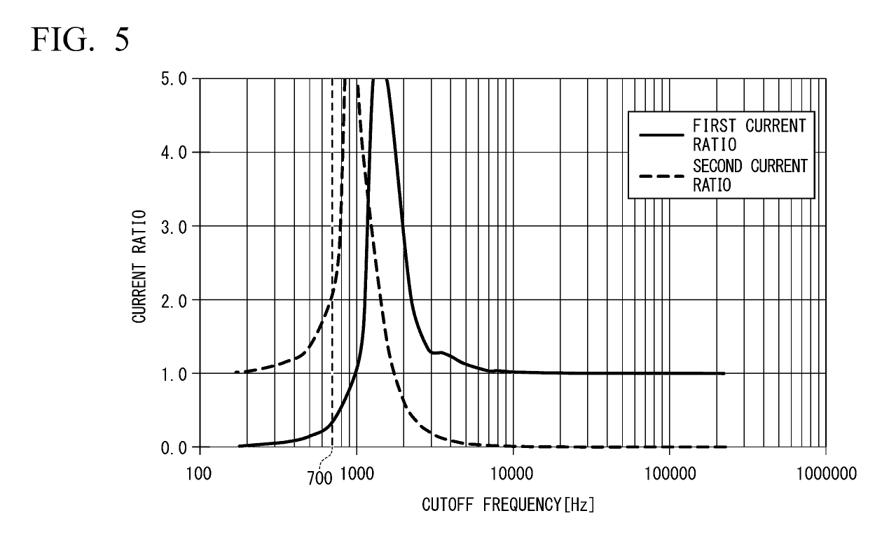

For example, in a certain simulation, the capacitance of the first capacitor C1 is 1 [mF], the capacitance of the second capacitor C2 is 1 [μF], and the driving frequency of the power transmission circuit 13 is 100 [kHz], it is preferable for the cutoff frequency of the effective low pass filter to be about 0.7 [kHz] or less. However, in this case, it can be preferable for the cutoff frequency to be a frequency equal to or lower than a frequency higher than 0.7 [kHz] due to an influence of other impedances such as the impedance of the rectification circuit 11A and the impedance of the power transmission circuit 13. Here, FIG. 5 is a graph showing still another example of respective changes in the first current ratio and the second current ratio with respect to the change in the cutoff frequency of the effective low pass filter when the inductance of the inductor L is changed. Specifically, FIG. 5 is a graph showing an example of respective changes in the first current ratio and the second current ratio with respect to the change in the cutoff frequency of the effective low pass filter when the inductance of the inductor L is changed in a case in which the capacitance of the first capacitor C1 is 1 [mF], the capacitance of the second capacitor C2 is 1 [μF], and the driving frequency of the power transmission circuit 13 is 100 [kHz].

As illustrated in FIG. 5, when the cutoff frequency of the effective low pass filter is 0.7 [kHz] or less, the second current ratio is equal to or higher than 1, whereas the first current ratio is lower than 1. That is, this indicates that, in a simulation performed by the inventors of the present invention, when the capacitance of the first capacitor C1 is 1 [mF], the capacitance of the second capacitor C2 is 1 [μF], and the driving frequency of the power transmission circuit 13 is 100 [kHz], it is preferable for the cutoff frequency of the effective low pass filter to be about 0.7 [kHz] or less. Here, in this simulation, in this case, the cutoff frequency being about 0.7 [kHz] or less corresponds to the inductance of the inductor L being about 5 [μH] or less.

As described above, the wireless power transmission device (in this example, the wireless power transmission device 10) according to the embodiment transmits the AC power to the power receiving coil (the power receiving coil L2 in this example) included in the wireless power reception device (the wireless power reception device 20 in this example). Further, the wireless power transmission device includes a power transmission coil (the power transmission coil L1 in this example) magnetically coupled to the power receiving coil, a rectification circuit (the rectification circuit 11A in this example) that rectifies the supplied AC voltage, a first capacitor (the first capacitor C1) that is provided between two output terminals of the rectification circuit and smooths a voltage supplied from the rectification circuit into a DC voltage, a power transmission circuit (the power transmission circuit 13 in this example) that converts the DC voltage smoothed by the first capacitor into an AC voltage at a driving frequency, and a second capacitor (the second capacitor C2 in this example) provided between two input terminals included in the power transmission circuit and bypasses between the two transmission paths connecting the rectification circuit and the power transmission circuit. Further, in the wireless power transmission device, the second capacitor is provided on the power transmission circuit side relative to the first capacitor between the rectification circuit and the power transmission circuit. Further, the wireless power transmission device includes an inductor (the inductor L) or a rectification element provided between the first capacitor and the second capacitor in the high potential side transmission path among the two transmission paths. Accordingly, the wireless power transmission device can prevent a lifespan of the capacitor that smooths the voltage rectified by the rectification circuit from being shorten.

In the wireless power transmission device, the inductor is provided between the first capacitor and the second capacitor in the high potential side transmission path among the two transmission paths connecting the rectifier circuit to the power transmission circuit. Further, in the wireless power transmission device, an inductance of the inductor is determined so that a cutoff frequency of a low pass filter constituted by the first capacitor and the inductor is lower than the driving frequency. Accordingly, it is possible to for the wireless power transmission device to more reliably prevent the reactive current from flowing from the power transmission circuit to the capacitor that smooths the voltage rectified by the rectification circuit.

Further, in the wireless power transmission device, the capacitance of the first capacitor, the capacitance of the second capacitor, and the inductance of the inductor are determined so that the current flowing from the power transmission circuit to the first capacitor (the first reactive current in this example) is lower than a current (a zero-th reactive current in this example) flowing from the power transmission circuit to the rectification circuit and is smaller than the current (the second reactive current in this example) flowing from the power transmission circuit to the second capacitor. Accordingly, it is possible to for the wireless power transmission device to more reliably prevent the reactive current from flowing from the power transmission circuit to the capacitor that smooths the voltage rectified by the rectification circuit.

Although the embodiment of the present invention has been described in detail with reference to the drawings, the specific configuration is not limited to this embodiment, and modifications, substitutions, deletions, and the like may be made without departing from the spirit of the present invention.

### EXPLANATION OF REFERENCES

1, 1X Wireless power transmission system
10, 10X Wireless power transmission device
11 Conversion circuit
11A Rectification circuit
12 Addition circuit
13 Power transmission circuit
14 Power transmission coil unit
20, 20X Wireless power reception device
21 Power receiving coil unit
22 Rectifying and smoothing circuit
C1 First capacitor
C2 Second capacitor
EV Electric car
G Ground
L Inductor
L1 Power transmission coil
L2 Power receiving coil
P Commercial power supply
Vload Load

What is claimed is:

1. A wireless power transmission device that transmits an alternating current (AC) power to a power receiving coil included in a wireless power reception device, the wireless power transmission device comprising:
a power transmission coil magnetically coupled to the power receiving coil;
a rectification circuit that rectifies a supplied AC voltage;
a first capacitor that is provided between two output terminals of the rectification circuit and smooths a voltage supplied from the rectification circuit into a direct current (DC) voltage;
a power transmission circuit that converts the DC voltage smoothed by the first capacitor into an AC voltage at a driving frequency; and
a second capacitor provided between two input terminals included in the power transmission circuit and bypassing between two transmission paths connecting the rectification circuit and the power transmission circuit,
wherein the second capacitor is provided on the power transmission circuit side relative to the first capacitor between the rectification circuit and the power transmission circuit, and
the wireless power transmission device includes an inductor or a rectification element provided between the first capacitor and the second capacitor in the high potential side transmission path among the two transmission paths.

2. The wireless power transmission device according to claim 1,
wherein in the high potential side transmission path, the inductor is provided between the first capacitor and the second capacitor, and
an inductance of the inductor is determined so that a cutoff frequency of a low pass filter constituted by the first capacitor and the inductor is lower than the driving frequency.

3. The wireless power transmission device according to claim 2,
wherein a capacitance of the first capacitor, a capacitance of the second capacitor, and the inductance are determined so that a current flowing from the power transmission circuit to the first capacitor is lower than a current flowing from the power transmission circuit to the rectification circuit and is lower than a current flowing from the power transmission circuit to the second capacitor.

4. A wireless power transmission system comprising:
the wireless power reception device, and
the wireless power transmission device according to claim 1.

5. A wireless power transmission system comprising:
the wireless power reception device, and
the wireless power transmission device according to claim 2.

6. A wireless power transmission system comprising:
the wireless power reception device, and
the wireless power transmission device according to claim 3.
